(19) United States
(12) Patent Application Publication
(10) Pub. No.: US 2015/0096447 A1
(43) Pub. Date: Apr. 9, 2015

(54) Grill Pan

(71) Applicant: HappyCall Co., Ltd., Gimhae-si, Gyeongsangnam-do (KR)

(72) Inventor: Hyun sam Lee, Yeonje-gu (KR)

(73) Assignee: HappyCall Co., Ltd., Gimhae-si, Gyeongsangnam-do (KR)

(21) Appl. No.: 14/399,589

(22) PCT Filed: Apr. 18, 2013
(86) PCT No.: PCT/KR2013/003285

§ 371 Date: Nov. 7, 2014

(30) Foreign Application Priority Data
May 7, 2012 (KR) 10-2012-0047912

(51) Int. Cl. A47J 37/10

(52) U.S. Cl. CPC A47J 37/101
USPC 99/422

(57) ABSTRACT

Disclosed is a direct fire grill pan including a grill pan with a heat inflow port formed therein, and a lid having an upwardly convex groove portion formed on a ceiling thereof and an exhaust port formed on a side wall thereof.

### TECHNICAL FIELD

This invention relates to a direct fire grill pan including a grill pan with a heat inflow port formed therein, and a lid having an upwardly convex groove portion formed on a ceiling thereof and an exhaust port formed on a side wall thereof.

### BACKGROUND ART

Examples of a conventional direct fire grill pan are disclosed in Korean Patent Application No. 10-1041220 and Korean Patent Laid-Open Publication No. 10-2011-0033167 which have been previously filed by the present applicant.

As shown in FIGS. 4 and 5, a conventional direct fire grill pan 100 is constituted of a grill pan 110 that forms an outer shape thereof and a lid 160 that covers the grill pan 110.

Additionally, it is preferable that a detachable hinge 170 be provided on one surface of the grill pan 110 and the lid 160, and a handle 180 be provided on the other surface thereof.

The grill pan 110 includes a bottom 111 with a heat inflow port 120 formed at the center thereof, and a side wall 115 that is bent upward at the edges of the bottom 111.

The lid 160 includes a ceiling 161 and a side wall 165 that is bent downward at the edges of the ceiling 161.

In addition, on the grill pan 110 or the lid 160, an exhaust port 118 is formed.

In the conventional direct fire grill pan 100 having the above-described configuration, when flame introduced into the heat inflow port 120 reaches the ceiling 161 as shown in FIG. 5, a heat flow in which the flame flows to the edges and side wall 165 along the ceiling 161 (flow similar to the concept of laminar flow and is exhausted to the exhaust port 118 is formed.

In such a heat flow, the flame does not reach well an upper surface of an object to be grilled, and therefore the grill efficiency is not much excellent.

### SUMMARY OF INVENTION

### Technical Problem

The present invention is directed to providing a direct fire grill pan which may implement a heat flow in which flame having reached a ceiling of the direct fire grill flows to an exhaust port while reaching well an upper surface of an object to be grilled.

### Solution to Problem

One aspect of the present invention provides a direct fire grill pan including: a grill pan that has a heat inflow port formed at a center of a bottom thereof and a side wall bent upward at edges of the bottom; a lid that has a ceiling to cover the grill pan and a side wall bent downward at edges of the ceiling; an exhaust port that is formed on the grill pan or the lid; and an upwardly convex groove portion that is formed on the ceiling of the lid.

In the direct fire grill pan, the groove portion may act as a guide for allowing flame introduced into the heat inflow port to flow downward, and therefore the flowing flame may be brought into close contact with an upper portion of an object to be grilled.

Preferably, the exhaust port may be an exhaust groove formed on a lower end surface of the side wall of the lid.

Preferably, the groove portion may have an uneven portion with convex and concave portions formed along a periphery thereof.

Another aspect of the present invention provides a direct fire grill pan including: a grill pan that has a heat inflow port formed at a center of a bottom thereof and a side wall bent upward at edges of the bottom; a lid that covers the grill pan; and an exhaust port that is formed on the grill pan or the lid. Here, an inclined surface that is inclined toward the outside of the lid may be formed on an inner surface of the lid.

### Advantageous Effects of Invention

According to the present invention, there are the following effects.

The upwardly convex groove portion is formed on the ceiling of the lid, so that the groove portion acts as a guide for allowing flame introduced into the heat inflow port to flow downward again from the groove portion, thereby forming a heat flow in which the flame is exhausted to the exhaust port while being brought into close contact with even the upper portion of the object to be grilled.

### BRIEF DESCRIPTION OF DRAWINGS

FIG. 1 is a perspective view showing a case in which a direct fire grill pan according to an embodiment of the present invention is closed;

FIG. 2 is a perspective view showing a case in which the direct fire grill pan of FIG. 1 is opened;

FIG. 3 is a cross-sectional view taken along line 3-3 of FIG. 1;

FIG. 4 is a perspective view showing a case in which a conventional direct fire grill pan is opened; and

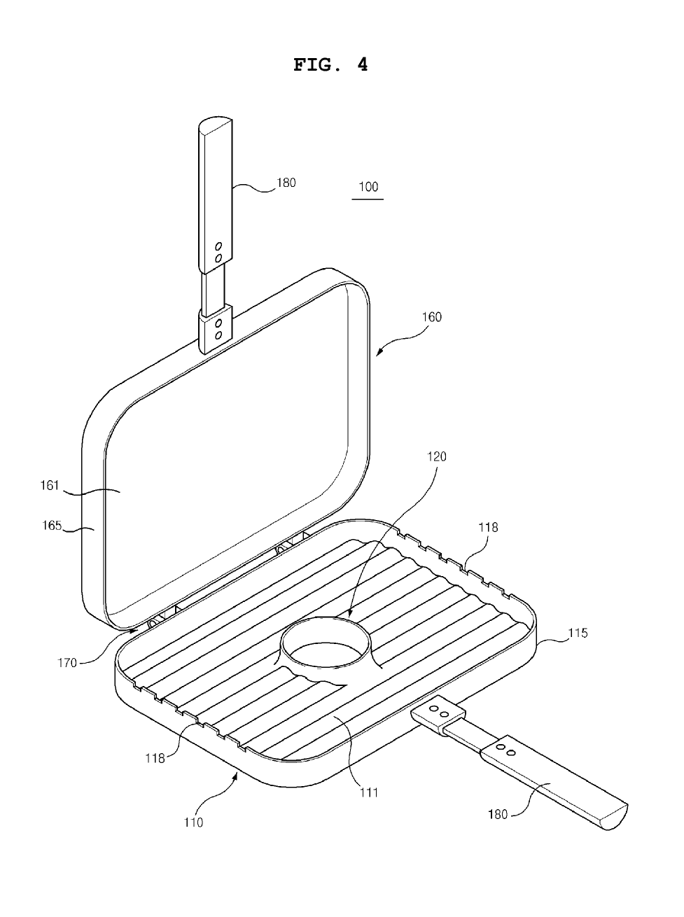

FIG. 5 is a cross-sectional view showing a case in which the conventional direct fire grill pan of FIG. 4 is closed.

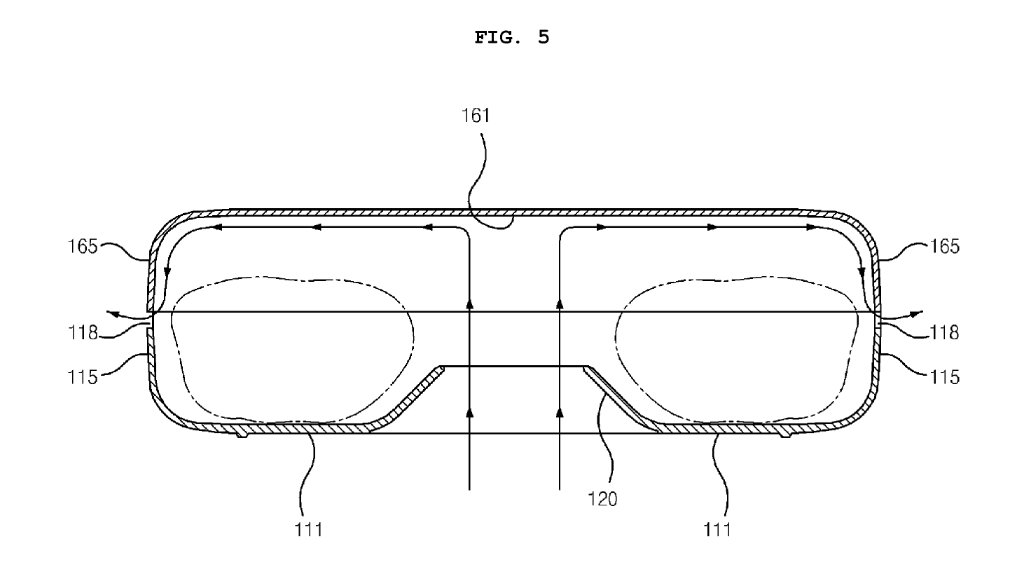

### DETAILED DESCRIPTION OF EMBODIMENT

Hereinafter, preferred embodiments of the present invention will be described in detail with the accompanying drawings. The same reference numerals will be given to the same parts as the conventional parts, and detailed description thereof will be omitted.

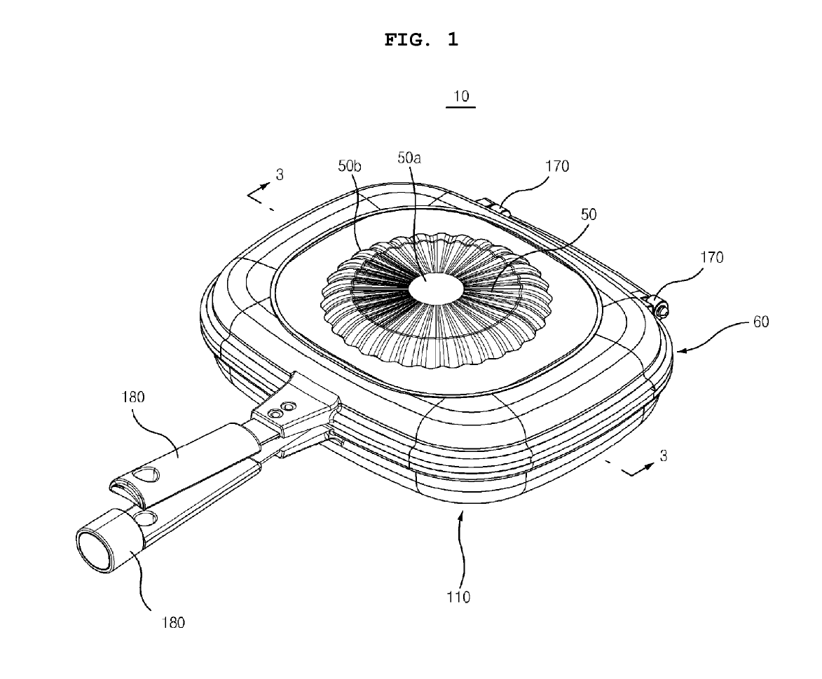

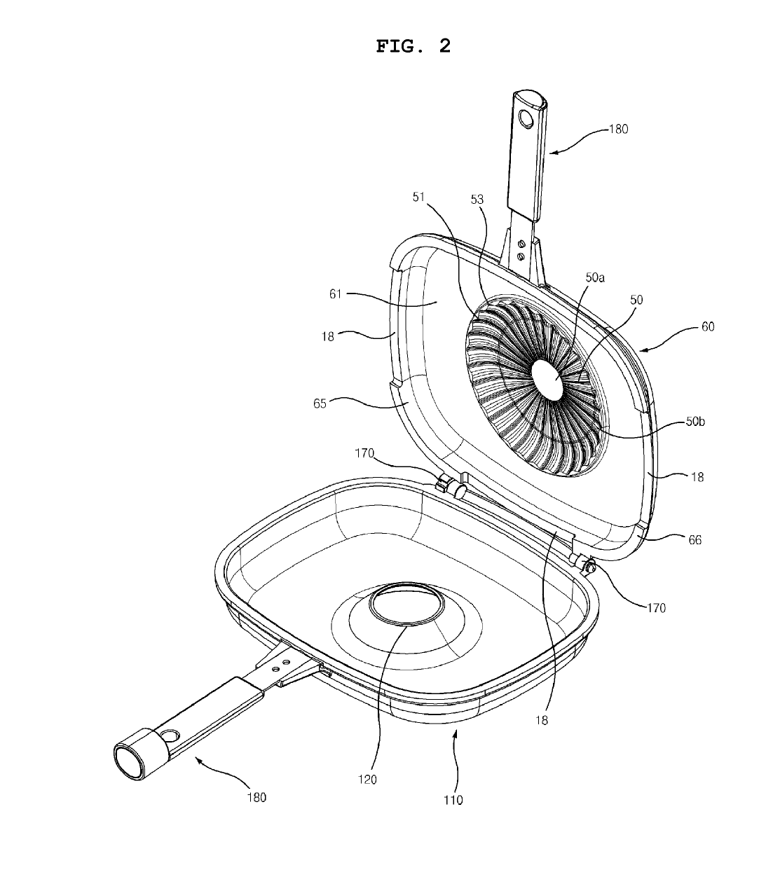

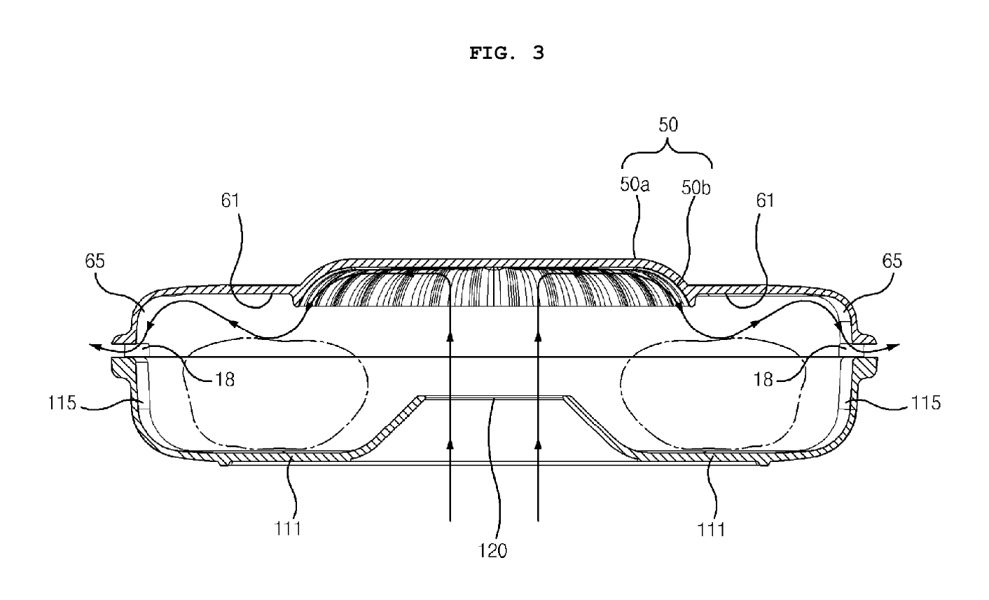

FIG. 1 is a perspective view showing a case in which a direct fire grill pan according to an embodiment of the present invention is closed, FIG. 2 is a perspective view showing a case in which the direct fire grill pan of FIG. 1 is opened, and FIG. 3 is a cross-sectional view taken along line 3-3 of FIG. 1.

As shown in FIGS. 1 to 3, the direct fire grill pan 10 according to an embodiment of the present invention includes a grill pan 110 that forms an outer shape of the direct fire grill pan 10, a lid 60 that covers the grill pan 110, and a groove portion 50 that is formed on the lid 60.

Additionally, it is preferable that a detachable hinge 170 be provided on one surface of the grill pan 110 and the lid 60, and a handle 180 be provided on the other surface thereof.

The grill pan 110 includes a bottom 111 on which an object to be grilled is placed, and a side wall 115 that is bent upward at edges of the bottom 111.

In addition, a hollow heat inflow port 120 is formed into a columnar shape at the center of the bottom 111.

The heat inflow port 120 may be formed into a trapezoidal shape whose diameter is reduced as approaching the top end thereof so as to converge flame.

The lid 60 includes a ceiling 61 and a side wall 65 bent downward at edges of the ceiling 61.

An exhaust port 18 is formed on a lower end surface 66 of the side wall 65. The exhaust port 18 may be implemented as an exhaust groove that is cut against the lower end surface 66 according to the present embodiment of the present invention, or implemented as an exhaust hole formed on the side wall 65.

The exhaust port 18 may be formed on the side wall 115 of the grill pan 110 instead of the lid 60.

Meanwhile, an upwardly convex groove portion 50 is formed at the center of the ceiling 61.

That is, it is preferable that the upwardly convex groove portion 50 be constituted of a flat upper surface 50a and an inclined surface 50b that is bent downward at edges of the upper surface 50a to meet the ceiling 61 according to the present embodiment of the present invention.

The inclined surface 50b may be formed on the upper surface 50a and formed into a shape (trapezoidal shape) whose diameter is increased as approaching the ceiling 61.

By the configuration of the groove portion 50, when flame is introduced into the heat inflow port 120 as shown in FIG. 3, the flame is first gathered inside the groove portion 50.

The flame inside the groove portion 50 flows along the upper surface 50a and flows downward (more specifically, in a direction in which the object to be grilled is placed) again in the inclined surface 50b.

Such a flow in the inclined surface has a heat flow in which flame flows in contact with the upper surface of the object to be grilled (flow similar to the concept of turbulence flow) rather than flowing immediately in contact with the ceiling 61 to be immediately exhausted to the exhaust port 18, or in which flame flows in contact with a part of the ceiling 61 and is exhausted to the exhaust port 18.

Thus, the object to be grilled is evenly grilled by heating and flame between the bottom 111 and the ceiling 61.

In addition, it is preferable that the groove portion 50 have an uneven portion with convex and concave portions 51 and 53.

The configuration of such an uneven portion acts as a guide for allowing flames to spread evenly in all directions.

Although the groove portion 50 that induces a heat flow in such a manner that the flame introduced into the heat inflow port 120 flows in contact with the upper portion of the object to be grilled rather than flowing along the ceiling to be immediately exhausted is implemented in an upwardly convex arc shape (umbrella-shape), it has the same function, which will be apparent to those skilled in the art.

In addition, the groove portion 50 may be provided as a separate component formed in the lid 60, but preferably, the groove portion 50 may be integrally formed with the lid 60.

Although a few embodiments of the present invention have been shown and described, it would be appreciated by those skilled in the art that changes may be made in these embodiments without departing from the principles and spirit of the invention, the scope of which is defined in the claims and their equivalents.

Obviously, even when the inclined surface inclined toward the outside of the lid 60 is formed on an inner surface of the lid 60 instead of the groove portion 50, the heat flow according to the present invention may be induced.

What is claimed is:

1. A direct fire grill pan comprising:
a grill pan that has a heat inflow port formed at a center of a bottom thereof and a side wall bent upward at edges of the bottom;
a lid that has a ceiling to cover the grill pan and a side wall bent downward at edges of the ceiling;
an exhaust port that is formed on the grill pan or the lid; and
an upwardly convex groove portion that is formed on the ceiling of the lid.

2. The direct fire grill pan of claim 1, wherein the exhaust port is an exhaust groove formed on a lower end surface of the side wall of the lid.

3. The direct fire grill pan of claim 1, wherein the groove portion has an uneven portion with convex and concave portions formed along a periphery thereof.

4. A direct fire grill pan comprising:
a grill pan that has a heat inflow port formed at a center of a bottom thereof and a side wall bent upward at edges of the bottom;
a lid that covers the grill pan; and
an exhaust port that is formed on the grill pan or the lid,
wherein an inclined surface that is inclined toward the outside of the lid is formed on an inner surface of the lid.

5. The direct fire grill pan of claim 2, wherein the groove portion has an uneven portion with convex and concave portions formed along a periphery thereof.
